(19) United States
(12) Patent Application Publication
(10) Pub. No.: US 2010/0183184 A1
(43) Pub. Date: Jul. 22, 2010

(54) EARPHONE

(76) Inventors: Lars Milde, Hannover (DE); Markus Kuhr, Singapore (SG)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 12/524,353

(22) PCT Filed: Jan. 29, 2008
(86) PCT No.: PCT/EP2008/000645

§ 371 Date: Mar. 22, 2010

(30) Foreign Application Priority Data
Jan. 29, 2007 (DE) 10 2007 005 159.1

(51) Int. Cl. H04R 1/10; H04R 25/00

(52) U.S. Cl. 381/381

(57) ABSTRACT

There is provided an earphone having an ear hook, at one end of which is arranged a first end of a sliding shaft and at the other end of which (at the ear lobe abutment end) the cable is fixed. The housing of the electroacoustic transducer is connected to the second end of the shaft in such a way that the housing of the electroacoustic transducer can be moved in the longitudinal direction of the shaft.

The present invention concerns an earphone.

DE 197 01 784 C1 discloses an earphone with an ear clip. The earphone has an electroacoustic transducer connected directly to a cable. In addition arranged on the housing of the electroacoustic transducer is a slidingly movable shaft cooperating with a sliding sleeve at one end of the ear clip in such a way as to permit a sliding movement of the shaft along its longitudinal axis. In that arrangement the ear clip is fixed to the sliding sleeve in such a way that a spiral-shaped or helical abutment end of the ear clip bears directly against the sliding sleeve. The ear clip is thus formed from a spiral-shaped or helical abutment end, an arcuately curved hook portion and an abutment end at an ear lobe end.

The object of the present invention is to provide an earphone which permits improved wearing comfort.

That object is attained by an earphone as set forth in claim 1.

Thus there is provided an earphone having an ear hook, at one end of which is arranged a first end of a sliding shaft and at the other end of which (at the ear lobe abutment end) the cable is fixed. The housing of the electroacoustic transducer is connected to the second end of the shaft in such a way that the housing of the electroacoustic transducer can be moved in the longitudinal direction of the shaft.

Further configurations of the invention are subject-matter of the appendant claims.

The embodiments by way of example of the invention and the advantages of the invention are described in greater detail with reference to the accompanying drawing.

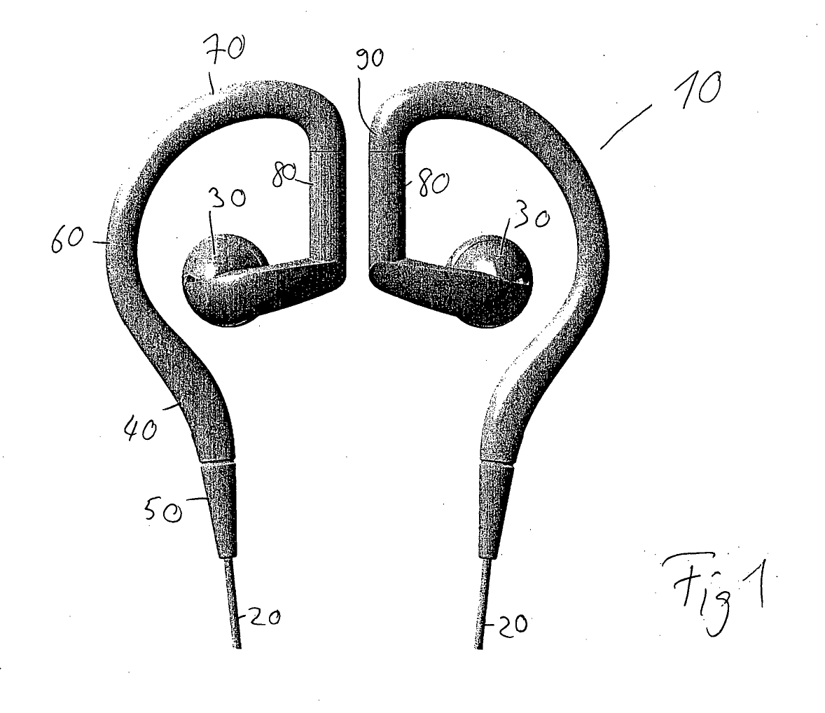

FIG. 1 shows a diagrammatic view of an earphone in accordance with the first embodiment, and

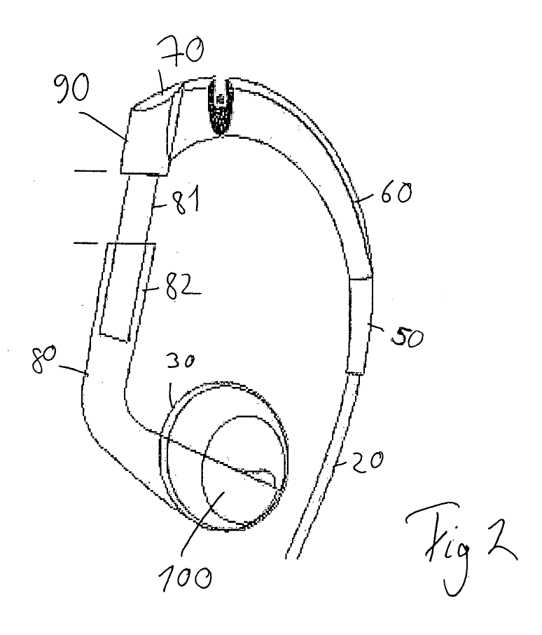

FIG. 2 shows a diagrammatic view of the earphone in accordance with a second embodiment.

FIG. 1 shows a diagrammatic view of an earphone in accordance with the first embodiment. The earphone 10 is in the form of an ear clip or ear hook earphone. For that purpose the earphone has a housing 30 for the electroacoustic transducer. In this case the housing 30 is preferably integrally connected to the housing portion 80. The earphone further has the ear clip 70, 60, 40. A shaft or a tube 81 is fixed at the first end 90 of the ear clip. The feed cable 20 is fixed at the second end of the ear clip 50. A first portion 40 of the ear clip is supported in the region of the ear lobe of the wearer when the earphone is being worn. A second portion 60 of the ear clip and a third portion 70 of the ear clip bear against the ear root of the wearer when the earphone is being worn.

FIG. 2 shows a diagrammatic view of an earphone in accordance with a second embodiment. In this case the second embodiment is essentially based on the first one. Thus the earphone is in the form of an ear clip or ear hook earphone. The housing 30 of the electroacoustic transducer 100 is adjoined by a housing portion 80 which is preferably of a cylindrical configuration. In this case the ear clip or the ear hook is substantially of a hook-shaped configuration. A (slidably movable) shaft 81 is mounted at its first end 90. The cable 20 for the earphone is arranged at its second end 50. An element 82 for receiving the shaft 81 is arranged in the housing portion 80 in such a way that the housing portion 82 and the housing of the electroacoustic transducer is movable in the longitudinal direction of the shaft 81.

The fact that the feed cable is introduced at the second end 50 of the ear clip means that the cable has to be passed through the ear clip 50, 60, 70, 90 to the shaft 81 and through the shaft 81 to the housing portion 80 and to the housing 30 to be connected to the electroacoustic transducer 100.

The fact that the cable 20 is not connected directly to the electroacoustic transducer as in DE 197 01 784 C1 but is passed by way of the ear clip or the ear hook to the electroacoustic transducer means that the cable 20 can be guided in a more pleasant way. While the cable hangs down forwardly in DE 197 01 784 C1, the cable 20 in the earphones in the first and second embodiments can be guided downwardly behind the ear. On the one hand that is more comfortable to wear and on the other hand the cable 20 does not interfere when the head of the user is moved.

1. An earphone comprising:
an ear hook which has a first and a second end,
a shaft fixedly connected to the first end of the ear hook,
a cable fixed to the second end of the ear hook, and
a housing for an electroacoustic transducer, which housing is fixedly connected to a housing portion serving to receive the shaft in such a way that the housing portion with the housing is movable in the longitudinal direction of the shaft.

2. An earphone as set forth in claim 1 wherein the ear hook comprises a flexible material.

3. An earphone as set forth in claim 1 wherein the cable is passed from the second end of the ear hook, through the ear hook to the second end of the ear hook, through the shaft, and through the housing portion and the housing to the electroacoustic transducer.
